(19) United States
(12) Patent Application Publication
(10) Pub. No.: US 2005/0060166 A1
(43) Pub. Date: Mar. 17, 2005

(54) Method of providing funeral products and services

(76) Inventors: Jon A. Durham, Scotts, MI (US); Herbert R. Ayres III, Plainwell, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/662,717

(22) Filed: Sep. 15, 2003

(51) Int. Cl. G06F 17/60

(52) U.S. Cl. 705/1

(57) ABSTRACT

A method of providing funeral products and services includes showing client family members an audio-visual presentation that is initially substantially void of funeral-related product information. The funeral home electronically transmits the information concerning the decedent to a central processing facility. The family members are asked questions concerning the life of the decedent, and a life story including information concerning the life of the deceased is created. The life story is utilized to create first and second videos including text and photographs of the decedent. The life story is also utilized to create a variety of printable electronic files. The first and second videos and the printable files are electronically transmitted from the processing center to the funeral home. The videos are shown during visitation at the funeral home, and during the memorial service. The funeral home director prints the printable material and utilizes the printed items for the funeral service, and to provide the family members with printed items that can be saved in memory of the decedent.

### BACKGROUND OF THE INVENTION

When an individual passes away, the family members and/or other loved ones generally plan the funeral and take care of many of the related matters. In general, the family members of the deceased will have an initial meeting at a funeral home known as an “arrangement conference”. At the arrangement conference, the family members are typically shown a variety of funeral related goods. Cards, flowers, a headstone, and other such matters are also typically selected at the arrangement conference. Immediately following the death of a loved one, the family members are understandably bereaved, and in a distressed mental state. Accordingly, the arrangement conference can be traumatic to the family members because they are confronted with the caskets and the like, and must make product purchasing decisions at this time.

### SUMMARY OF THE INVENTION

One aspect of the present invention is to provide an audio-visual presentation at an arrangement conference. The audio-visual presentation provides information concerning the purpose of funerals, and shifts the focus from the selection of a coffin and the like to a celebration of the life of the decedent. The funeral director asks the family members and/or other loved ones questions concerning the life of the deceased. The interaction between the funeral director and the family members fosters a supportive environment during a difficult time for the family members, and further serves to de-emphasize the product selection process. The funeral director electronically transmits the information concerning the life of the decedent to a central processing location. The funeral director also electronically scans photographs and the like of the decedent, and electronically transmits the images to the central processing facility. Writers, employed by the company, write a story based on the information concerning the life of the decedent which was transmitted from the funeral director. The writing of text describing the life of the decedent (also referred to as the Life Story and used interchangeably) and the proofreading/approval of the Life Story occur on the website. After the initial Life Story is written technicians at the processing facility create a first audio-visual work based upon the Life Story written by the writers and photographs transmitted by the funeral director. The first audio-visual work includes photos of the deceased and text describing various aspects of the life of the decedent. The technicians also create a second audio-visual work showing the life of the decedent that is substantially shorter than the first audio-visual work. The technicians also produce a non-video life story of the decedent in a printable format. The non-video life story includes pictures of the decedent and text describing the life of the decedent.

The technicians electronically transmit the first and second audio-visual works and the non-video visual pieces to the director of the funeral home. The director of the funeral home then creates a “hard” copy of the audio-visual works on a CD, DVD or the like, and also prints the memory folders having photographs and text concerning the decedent. The technicians also create a life panel including pictures of the decedent. The life panel is in a printable format. When printed, the life panel is in the form of a horizontally elongated strip of paper that can be placed in an appropriate area for visitation or service.

A website is provided for the funeral home, and includes a memorial webpage for the decedent. The memorial webpage includes the photographs and text from the life story, and also provides for input of memories concerning the decedent by individuals located remotely from the funeral home via the internet. The website also includes facilities for ordering memorial items such as flowers and/or to make a memorial donation.

During visitation, the funeral director positions a display screen in the visitation room. The first audio-visual work is shown on the display screen during visitation, and provides visitors with information concerning the life of the decedent. One or more kiosks are also provided during visitation, either in the visitation room or a common area of the funeral home. The kiosks each include a computer terminal that is connected to the internet to provide access to the website. Thus, visitors can input their memories of the decedent on the website at the funeral home during visitation. The funeral director also positions the life panel in or adjacent to the coffin or in the visitation room if the coffin is not present during visitation to provide visitors with a pictorial timeline of the decedent's life.

During the service, the funeral director may provide visitors with copies of the memory folder including text and photographs of the decedent, and the second audio-visual work is shown on a projection display screen during the service.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is a perspective view of a funeral home illustrating the showing of an audio-visual presentation during the arrangement conference;

FIG. 1A is a view of the screen of FIG. 3 wherein a plurality of packages of funeral goods are displayed;

FIG. 2 is a flowchart illustrating the method of providing funeral-related goods and services according to one aspect of the present invention;

FIG. 3 is a flowchart illustrating the method of providing funeral-related goods and services according to one aspect of the present invention;

FIG. 4 is a partially schematic plan view of a funeral home illustrating the positioning of the kiosk and display screen during visitation at the funeral home;

FIG. 4A is a partially schematic view of a LIFE PANEL;

FIG. 5 is the main webpage utilized by a funeral home according to another aspect of the present invention;

FIG. 5A is a schematic drawing o the services provider and individual funeral homes that are members of the network;

FIG. 6 is an obituary and memory page on the website reached by selecting the link on the page illustrated in FIG. 5;

FIG. 7 is a partially fragmentary illustration of a portion of an obituary page that is reached by selecting the appropriate name link on the page of FIG. 6;

FIG. 8 is another portion of the webpage of FIG. 7 illustrating the MEMORIES portion of the webpage;

FIG. 9 is a webpage that can be utilized by remote users to post memories on the webpage of FIG. 8;

FIG. 10 is a webpage enabling remote users to enter their names in the webpage guestbook that can be reached by selecting the link from FIG. 8;

FIG. 11 is a webpage showing the guestbook that can be reached by selecting the link in FIG. 8;

FIG. 12 is a memory folder in a printable format that can be downloaded by selecting the DOWNLOAD MEMORY FOLDER link from the webpage of FIG. 8;

FIG. 13 is a webpage enabling remote users to send flowers that can be reached by selecting the SEND FLOWERS link on the webpage of FIG. 8;

FIG. 13A is a webpage utilized by remote users to order flowers; and

FIG. 14 is a webpage enabling remote users to make a memorial contribution that can be reached by selecting the MAKE A MEMORIAL CONTRIBUTION link from the webpage of FIG. 8.

### DETAILED DESCRIPTION OF PREFERRED EMBODIMENT

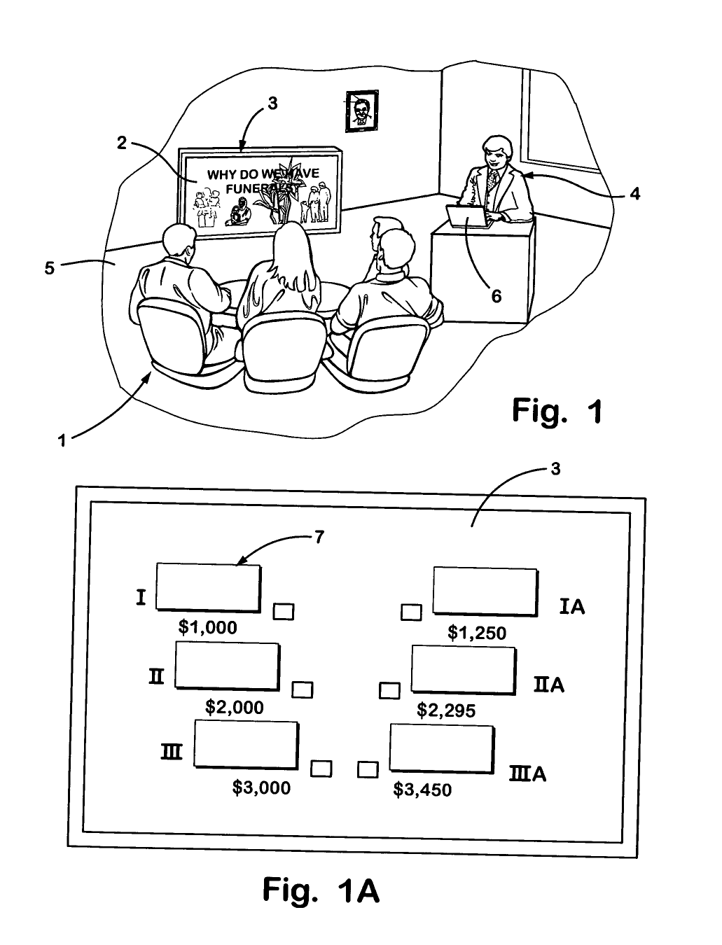

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

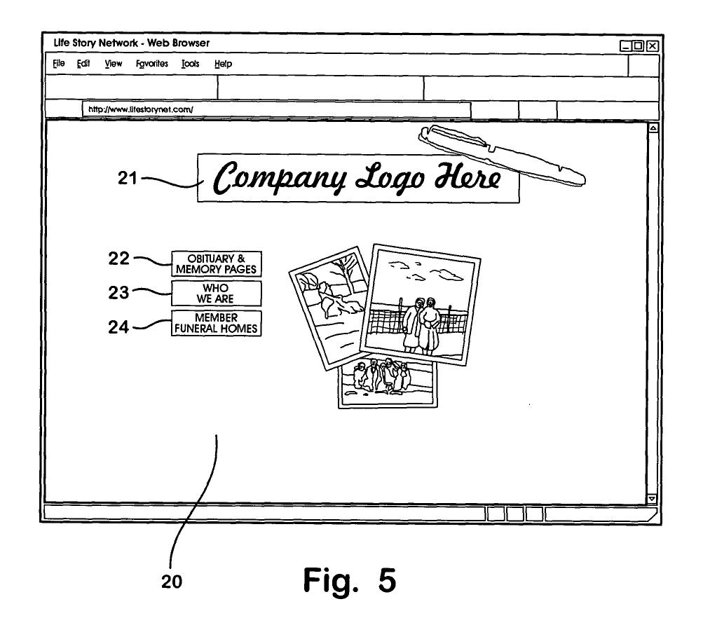

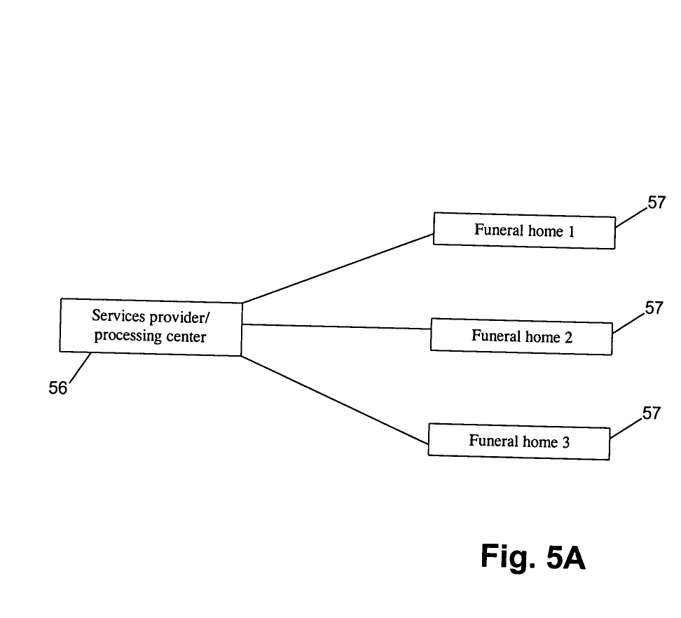

As discussed in more detail below in connection with FIG. 5A, one or more funeral homes 57 are in communication with a central processing center 56 via the internet. The processing center 56 is a facility utilized by a SERVICES PROVIDER company to provide products and services to the individual funeral homes. The individual funeral homes 57 provide the products and services to the customer (i.e. client family).

With reference to FIG. 1, according to the present invention, family members 1 of the decedent (“client family”) are initially shown an audio-visual presentation 2 on a display screen 3 by a funeral home director 4 at the funeral home 5 during an arrangement conference. The audio-visual presentation is in the form of pictures and text that initially provide the family members with information concerning the reason for having funerals, and also provides comfort to the family members by indicating that funerals are similar to weddings, anniversaries, birthdays and other celebrations because they mark a change in the lives of the family members and friends. The audio-visual presentation also facilitates shifting the focus to the celebration of the life of the deceased. The funeral director asks the family members various questions concerning the life of the decedent, and gathers information concerning the decedent's life from the family members and/or others in attendance. The audio-visual presentation 2 can be controlled by the funeral director 4, such that the funeral director may bring up a screen asking the family members specific questions concerning the life of the decedent. The funeral director also asks the family members to provide photographs and the like of the decedent.

With further reference to FIG. 1A, after the funeral director gathers information concerning the life of the decedent, the audio-visual presentation 2 switches to a screen having a plurality of images 7 on the display screen 3. Each of the images 7 corresponds to a package of goods and services, and includes pricing information for each package. Each package of goods and services includes all of the goods and services (casket, flowers, cards, embalming, cremation, etc.) required for the funeral. Also, the items in each package are coordinated to ensure the various products and services are compatible. Each of the packages (I-IIIA) includes a different combination of products. A price for each package is displayed adjacent each image 7, such that the client family can readily choose a package that falls within their budget. Once a particular package is selected, no further selection concerning specific flowers, cards, or the like is required. In this way, the family members know immediately the total cost of the particular package selected. Furthermore, the use of the display screen 3 eliminates the need to bring the family members into a product display room housing numerous coffins, thereby alleviating a major source of mental distress otherwise associated with traditional arrangement conferences. Also, because the flowers, casket, cards, and the like for a particular package are preselected, the lengthy process of selecting each product in detail is eliminated, thereby greatly reducing the total time for the arrangement conference, further alleviating the distress to family members that otherwise occurs during traditional arrangement conferences. Still further, each of the packages 7 is configured to ensure that the individual funeral home complies with the relevant government regulations.

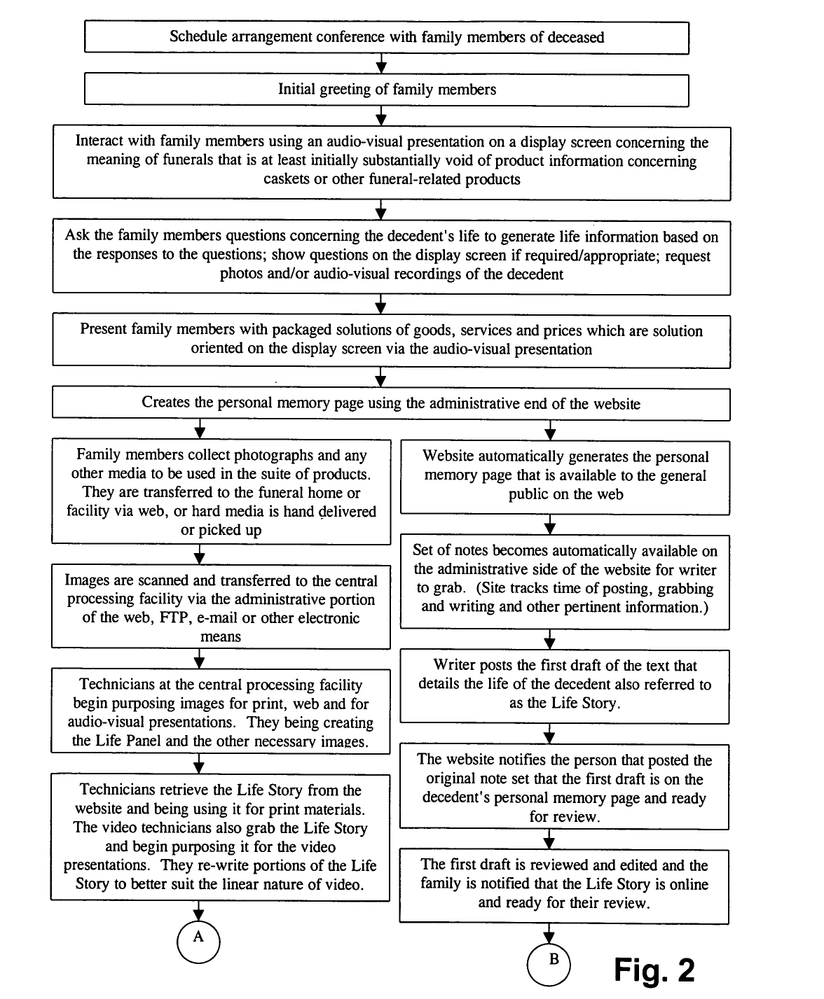

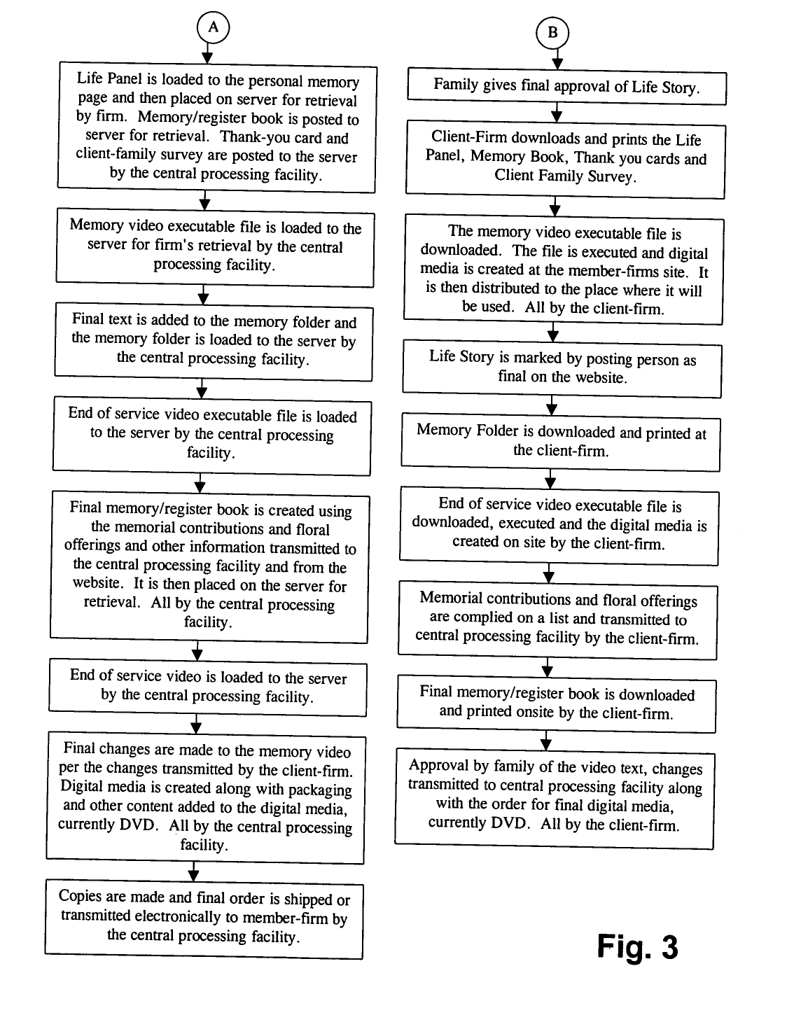

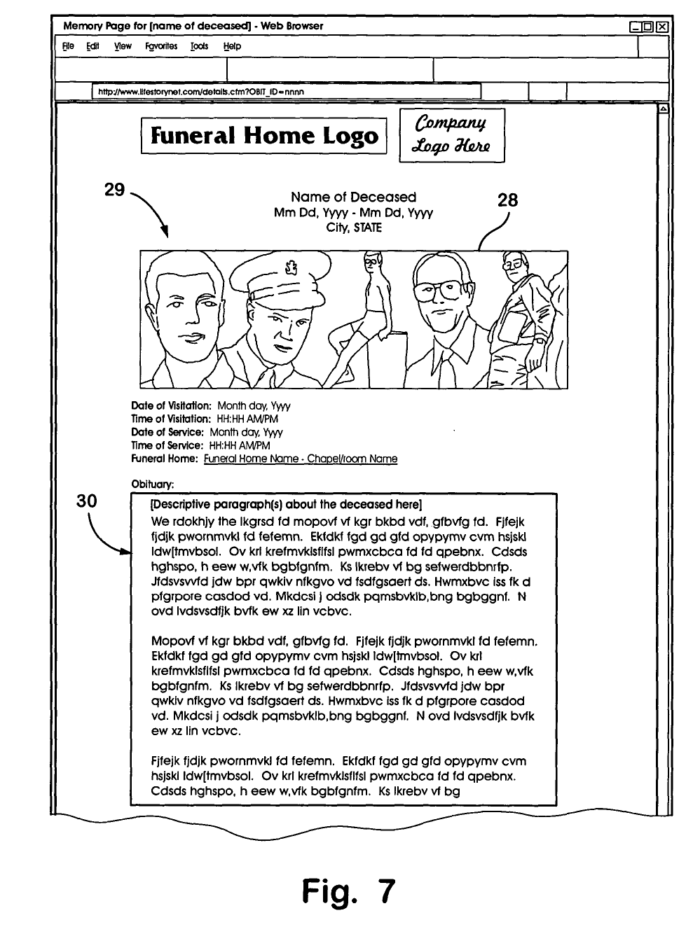

A flowchart illustrating the method of providing funeral products and services according to the present invention is shown in FIGS. 2 and 3. It will be readily understood that many of the steps need not be performed in the order shown. Also, the portions of the method that are conducted at the individual funeral home are shown in the right column in FIGS. 2 and 3, and the portions of the method that are conducted at the processing center are shown in the left column. After the family members select the desired package of goods, a website section is provided within the website of the funeral home. As discussed in more detail below, the website includes a memorial to the decedent, as well as memorials for other decedents for which the funeral home is providing services. After family members provide photos and the like of the decedent to the director of the funeral home, the funeral home director (or other funeral home personnel) convert the photos of the decedent into electronic format. The photographs and other information gathered by the funeral home director concerning the decedent are then transmitted electronically to a processing center. A webpage for the decedent/client family is then created on the funeral home website. The webpage includes a publicly accessible “side” discussed in more detail below in connection with FIG. 7, and also includes a “back side” that is only accessible by the director of the funeral home, the writers, and other authorized personnel. The writers put notes concerning the life of the decedent on the back side of the webpage. One or more writers at the processing center are trained in writing a LIFE STORY for the decedent based upon the information supplied by the family members and transmitted by the director of the funeral home. In contrast to a conventional obituary, the LIFE STORY includes detailed information concerning the life of the decedent. The photographs are converted into different electronic formats suitable for printing, display in a video format, and for display on a website.

The writers post a first draft of the LIFE STORY on the publicly accessible side of the website as an obituary 30 (FIG. 7). When the LIFE STORY is posted, an email is automatically sent to the funeral director. The email prompts the director to review the first draft of the LIFE STORY and the make any required changes. The funeral director then asks the client family to review the LIFE STORY on the website (i.e. obituary 30), and, if required, additional changes are made to create a final version of the LIFE STORY. A master file is then created that includes photos of the decedent in a printable format and the final version of the LIFE STORY in textual format describing the life of the decedent.

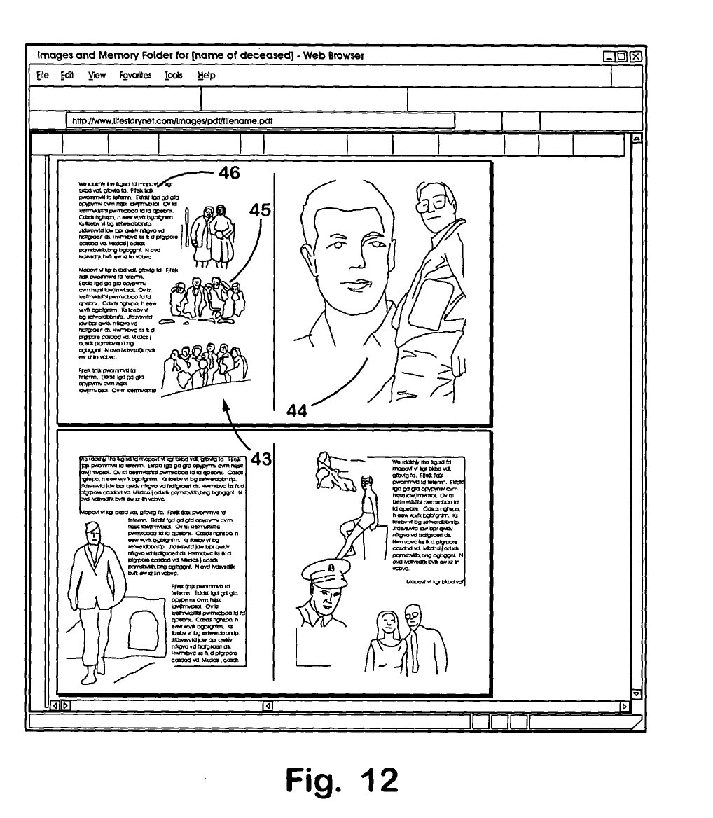

Various printable products are produced from the master file. A LIFE PANEL in printable format is created, and includes pictures of the decedent positioned in a side-by-side arrangement. The LIFE PANEL is produced in various sizes, such that the client family can purchase a printed LIFE PANEL in a size that is suitable for framing. In addition to the LIFE PANEL, a MEMORY FOLDER having text and photographs in printable format is also created. The MEMORY FOLDER is substantially identical to the webpage memorial described in more detail below in connection with FIG. 12, except that the MEMORY FOLDER is in a printable format. A MEMORY BOOK is also created from the master file, and includes text and photos substantially similar to the MEMORY FOLDER, and, when printed, further includes space for visitors to the funeral home to sign. ACKNOWLEDGEMENT CARDS (not shown) including text and/or photos are also created from the master file. The client family can send the ACKNOWLEDGEMENT CARDS to visitors and/or those who have made memorial contributions, sent flowers, and the like. A CLIENT SURVEY (not shown) is also created from the master file, and includes selected photos and/or text. The CLIENT SURVEY may be sent to the client family following the funeral to obtain information concerning the family's satisfaction with the goods an services provided by the funeral home.

The technicians utilize the information from the LIFE STORY and photographs that have been converted into a video format to create a first audio-visual work. The first audio-visual work includes a series of photographs of the decedent in a format suitable for display on the screen 3, with text adjacent the photographs describing the life of the decedent. The first audio-visual work also preferably includes appropriate music that further enhances the effect of the presentation.

In addition to the first audio-visual work, the technicians also create a second audio-visual work from the LIFE STORY and photos in video format. The second audio-visual work is substantially shorter than the first, and includes the same series of photographs of the decedent as the first audio-visual work, with limited text. The first audio-visual work is preferably about 10 minutes, and the second audio-visual work is preferably about 3-4 minutes.

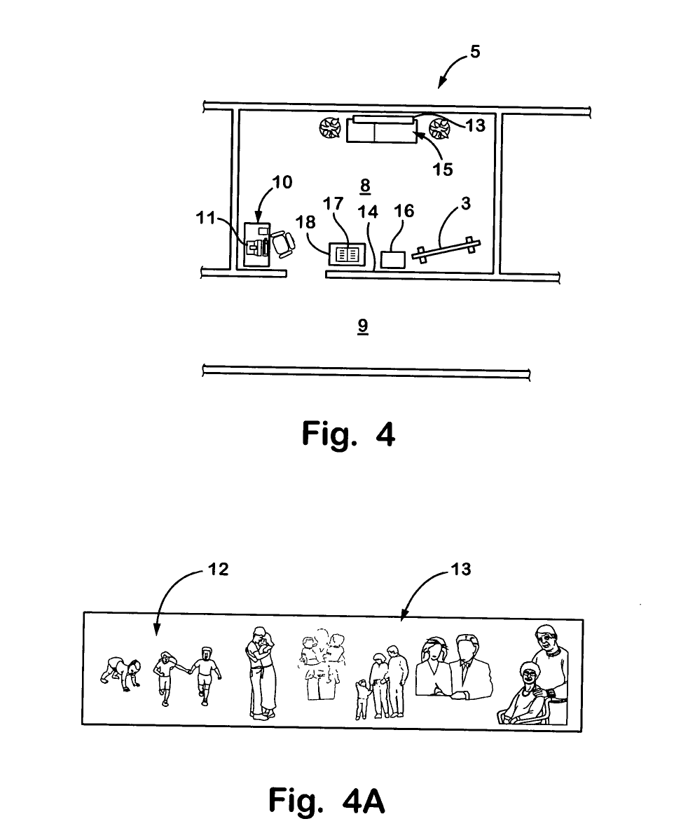

The writers then electronically transmit the first and second audio-visual works, the LIFE PANEL, MEMORY FOLDER, MEMORY BOOK, ACKNOWLEDGEMENT CARDS and CLIENT SURVEY from the processing center, as they are created, to the individual funeral home via a computer network. Upon receiving the first and second audio-visual works from the processing center, the funeral home director copies the audio-visual works onto a VCD, DVD or the like. After any required changes are made, the funeral home director prints the MEMORY FOLDERS, MEMORY BOOK, LIFE PANEL, ACKNOWLEDGEMENT CARDS, and CLIENT SURVEY. As illustrated in FIG. 4A, the LIFE PANEL 13 is printed on a horizontally elongated sheet of paper, and includes a series of photographs 12 of the decedent arranged in a side-by-side manner.

As also discussed in more detail below, the website includes a screen that permits users to remotely post MEMORIES information concerning the decedent via the internet. With reference to FIG. 4, the funeral home 5 includes one or more visitation rooms 8, as well as one or more common areas 9. A kiosk 10 is positioned in the visitation room 8 or the common area 9, and includes a computer 11 that is connected to the webpage via the internet. The kiosk 10 thereby permits visitors to the funeral home to input MEMORIES information on the website when they visit the funeral home. The display screen 3 is positioned within the visitation room 8. Although the screen 3 may be located anywhere in the visitation room, the screen 3 is preferably positioned adjacent an opposite wall 14 away from the casket 15. Alternately, the screen 3 may be positioned in the common area 9. The display screen 3 is electrically connected to a computer or DVD player 16. The first audio-visual work is played on the screen 3 during visitation to provide information concerning the life of the decedent to the visitors. During visitation, the LIFE PANEL 13 is preferably positioned on or adjacent the casket 15 to provide a summary of the life of the decedent or in the visitation room if no casket is present. The MEMORY BOOK 17 may be placed on a desk 18 or the like in or adjacent the visitation room 8.

During the memorial service for the decedent, visitors may be provided with MEMORY FOLDERS containing a blank form for the writing of personal memories. The MEMORY FOLDER is designed to be read as those in attendance read along and recall pertinent memories they may have. During the memorial service, the second audio-visual work is displayed on a large projection screen, at the end of the service.

In a preferred embodiment, the display screen 3 is a large plasma screen. It has been found that the plasma screen provides a very desirable effect during the arrangement conference, as well as during the visitation. Also, as discussed above, the audio-visual presentation that is originally presented to the family members at the arrangement conference includes a series of video portions at the beginning along with text explaining the purpose and meanings of funerals. The audio-visual presentation provides a comforting environment for the family members, and allows them to express their loss. However, the audio-visual presentation does not initially include any information concerning caskets or other goods to be purchased from the funeral home. In this way, the family members are initially encouraged to view the funeral as a celebration of the life of the decedent, and the family members are not initially confronted with a large number of caskets or the like and required to make a choice as in conventional arrangement conferences. Also, as discussed above, following the initial portion of the audio-visual presentation 2 discussing the purpose of funerals, the funeral home director will ask the family members questions concerning the life of the decedent. This provides an interactive environment between the funeral home director and the family members, and the family members develop a degree of trust and comfort level with the funeral home director. This stage of the process also serves to de-emphasize the selection of caskets or the like with which family members are normally confronted with at an arrangement conference. Also, as described above in connection with FIG. 1A, the various packages of coffins and related products are presented after the funeral home director obtains information from the family members concerning the life of the decedent. Because the information is displayed discreetly on the screen 3, the family members are not required to enter a display room and select from actual caskets. Also, because each of the packages of goods includes not only the casket but also the other required items, the family members are not required to expend a large amount of time and effort selecting each of the individual items required for the funeral.

According to the present invention, the SERVICES PROVIDER is a company that employs the writers, technicians, and other support personnel at a processing center 56 to provide writing services for the individual funeral homes (FIG. 5A). Each of the funeral homes 57 who are a part of the network forward their information to the SERVICES PROVIDER for processing to provide the various audio-visual and other printable works described in more detail above. Also, the SERVICES PROVIDER initially consults with the individual funeral homes, and supplies the display screen 3, computer 6, software, printers (not shown), scanners (not shown), and the like. The SERVICES PROVIDER also provides the audio-visual presentation 2 that is utilized during the arrangement conference with the individual families. The writers may be located at the processing center, or they may work off-site by accessing the back side of the webpage via the internet.

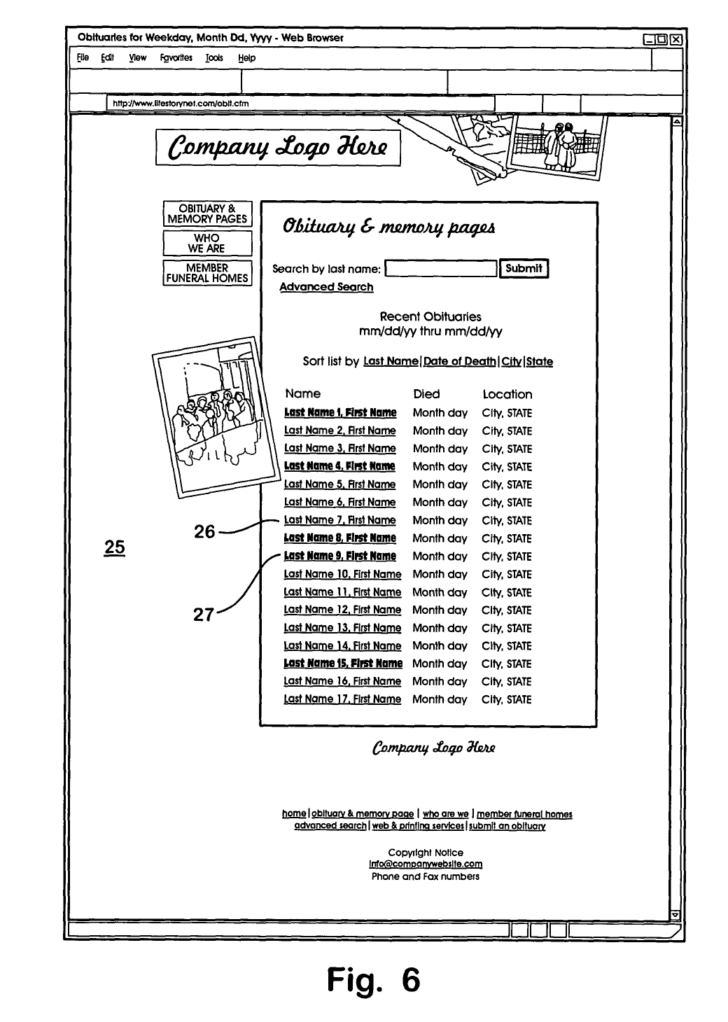

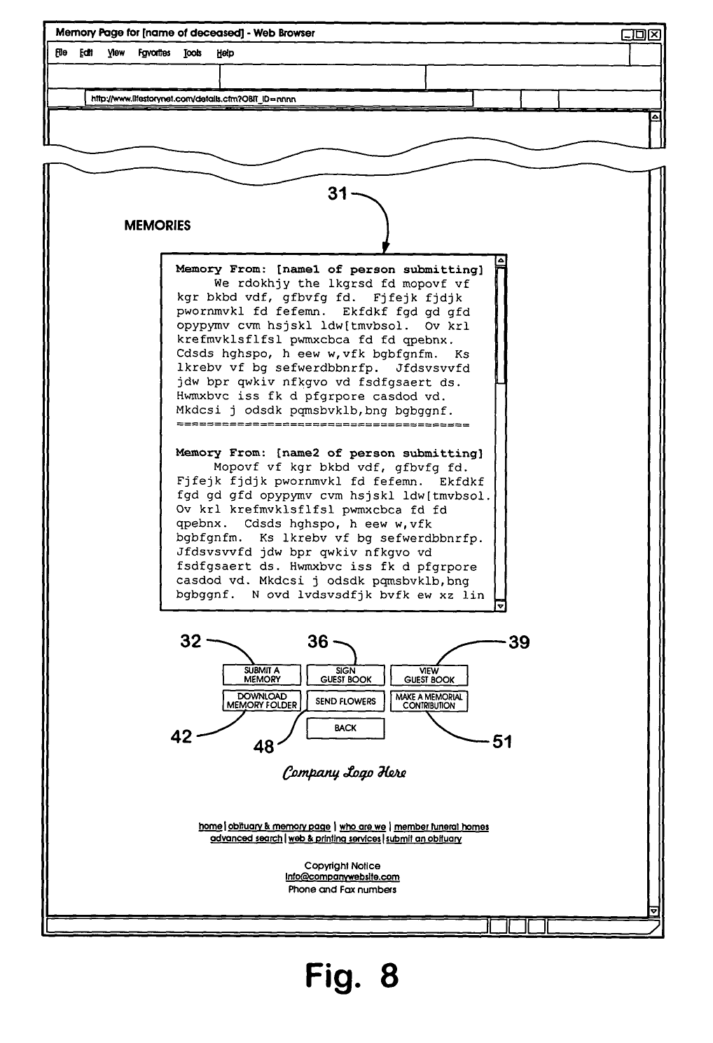

The SERVICES PROVIDER also provides a webpage 20 (FIG. 5) for the individual funeral homes. The home webpage 20 for each individual funeral home includes the name 21 of the funeral home and also includes a link 22 to the OBITUARY & MEMORIES PAGES. The webpage 20 also includes a link 23 providing more information concerning the particular funeral home, and a link 24 that lists other funeral homes who are members of the network (i.e. utilize the audio-visual presentation 2 and other services of the SERVICES PROVIDER). The link 22 connects to the OBITUARY & MEMORY PAGES webpage 25 illustrated in FIG. 6. A plurality of links 26 are provided on webpage 25, each of which is in the form of the name of a decedent for which the funeral home is providing services. Some of the links 27 are in bold, and these bold links 27 represent links that include an obituary page 29 as illustrated in FIG. 7. If a particular family so desires, the obituary can be omitted from the webpage, and the corresponding links 26 are not in bold text, and do not link to an obituary page. The obituary page 29 includes text 30 describing the life of the decedent, and also includes a series of photographs 28 corresponding to the LIFE PANEL 13 described above. Text 30 is preferably the LIFE STORY. The obituary page 29 also includes a MEMORIES portion 31 (FIG. 8) showing information entered by various individuals on the website.

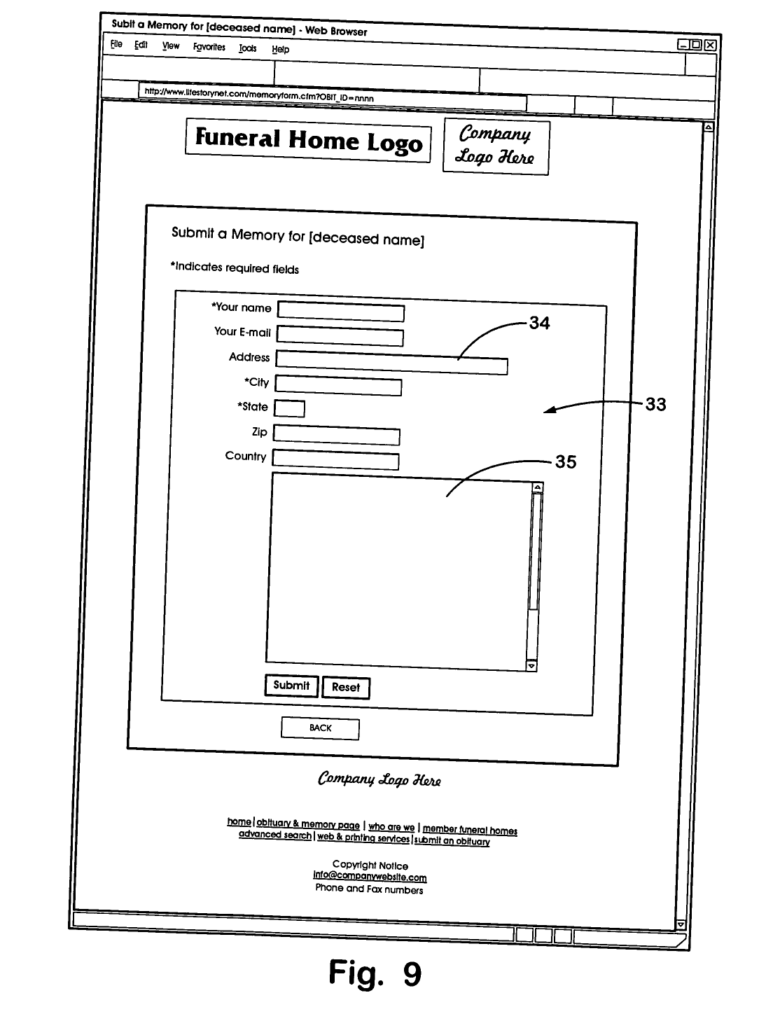

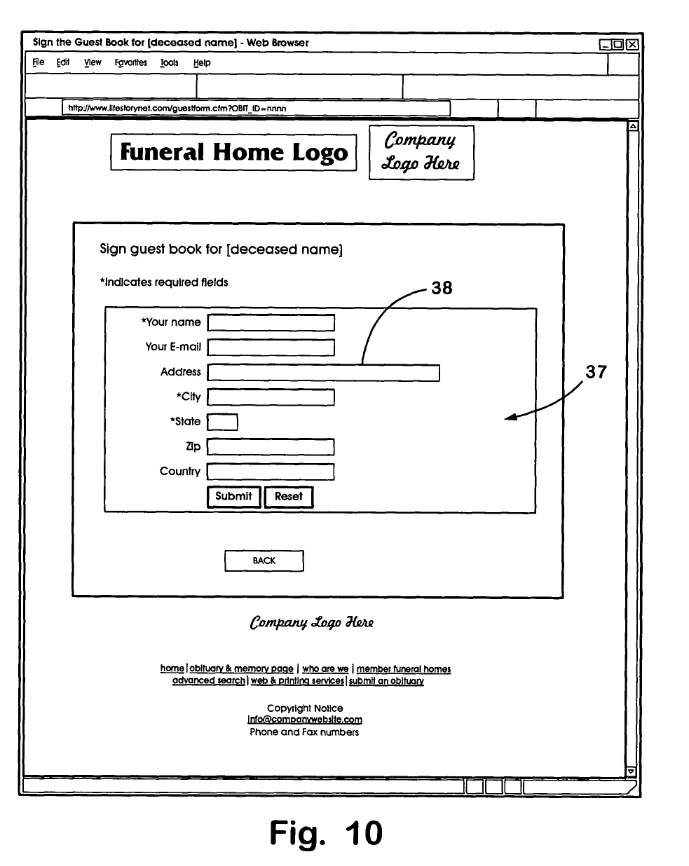

The obituary webpage 29 also includes a SUBMIT A MEMORY link 32 that is linked to a webpage 33 (FIG. 9) that includes a series of fields 34 to enter information concerning the person posting the MEMORIES. The information concerning the decedent is entered in the field 35 by the user. As discussed above, this information can be entered at either the funeral home utilizing a kiosk 10, or it can be entered by a remote user by accessing the appropriate webpage 33 via the internet. The webpage illustrated in FIG. 8 includes a SIGN GUESTBOOK link 36 that is linked to the “sign guestbook” webpage 37 illustrated in FIG. 10. The webpage 37 includes various fields 38 into which information concerning the remote user can be entered to “sign” the guestbook.

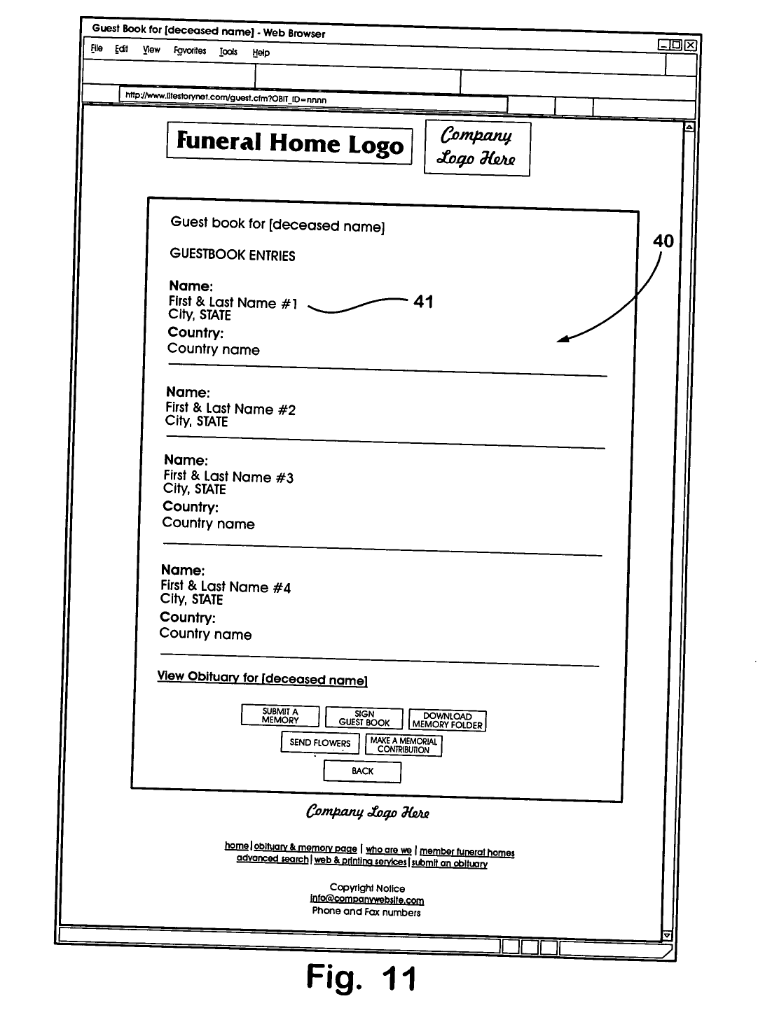

The obituary webpage 29 illustrated in FIG. 8 also includes a VIEW GUESTBOOK link 39 that that is linked to a GUESTBOOK webpage 40 (FIG. 11) that includes names and other information 41 relating to individuals who have “signed” the guestbook utilizing the webpage 37 illustrated in FIG. 10.

The obituary and memories webpage 29 illustrated in FIG. 8 also includes a DOWNLOAD MEMORY FOLDER link 42 that is linked to webpage 43 (FIG. 12). The MEMORIES FOLDER 44 includes photographs 45 and text 46 (i.e. LIFE STORY) illustrating the life of the decedent. In a preferred embodiment, the MEMORY FOLDER 44 is in a printable format that is automatically downloaded when the DOWNLOAD MEMORY FOLDER 42 link (FIG. 8) is selected. In this way, remote users can download and print a high resolution color copy of the MEMORY FOLDER 44 that can be saved in memory of the decedent.

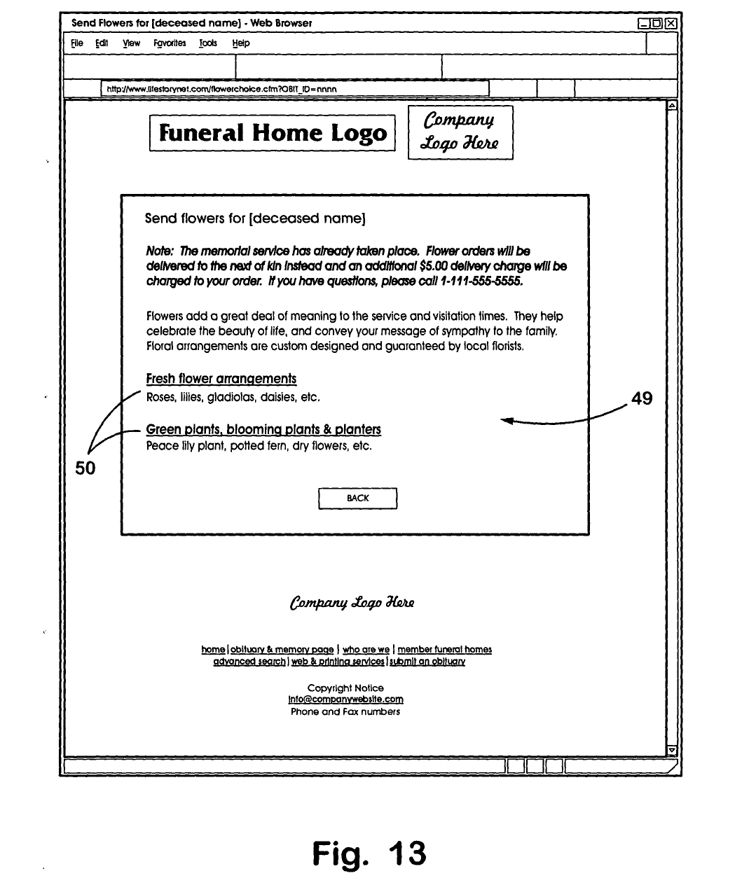

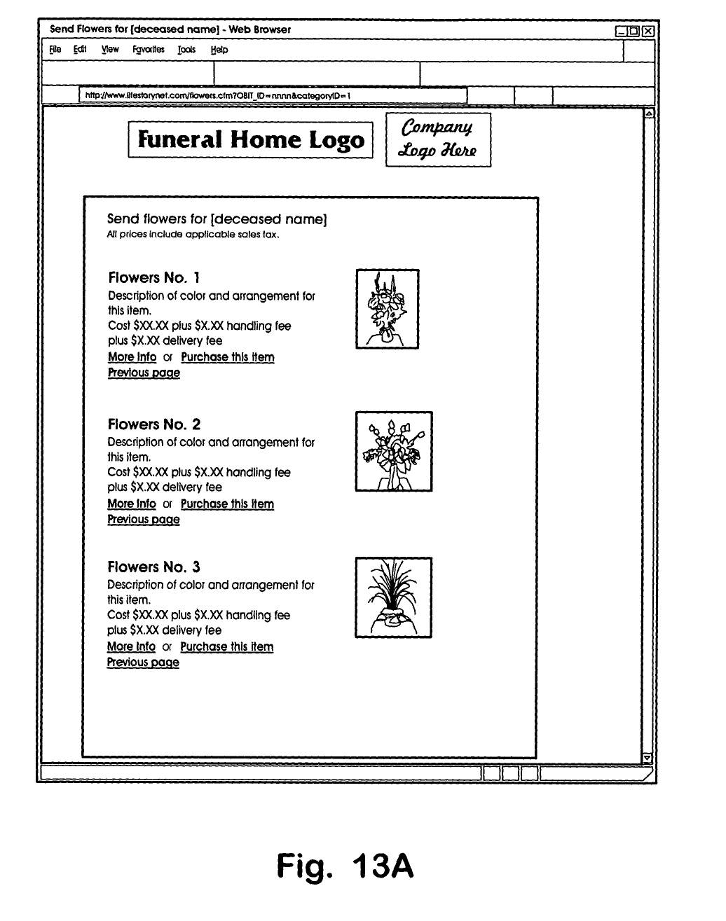

The obituary and memories page 29 of FIG. 8 also includes a SEND FLOWERS link 48 that is linked to a SEND FLOWERS webpage 49 illustrated in FIG. 13. The webpage 49 includes information and links 50 to a webpage 54 (FIG. 13A) that provides additional information and ordering capability for remote users.

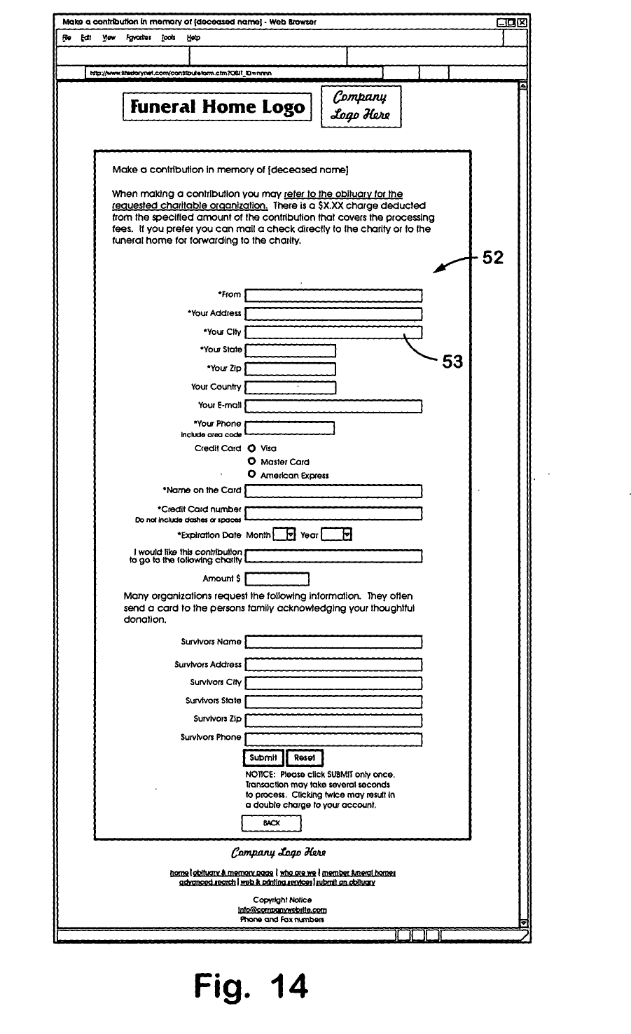

The obituary and memories page 29 of FIG. 8 also includes a MAKE A MEMORIAL CONTRIBUTION link 51 that is linked to a MAKE MEMORIAL CONTRIBUTION webpage 52 illustrated in FIG. 14. The webpage 52 includes fields 53 for entering information concerning the donor, as well as credit card information and the like for making the donation remotely via the internet.

The present invention provides a way for funeral directors to present family members with an audio-visual presentation during the arrangement conference in a manner that encourages the family members to celebrate the life of the decedent. Furthermore, the interaction between the funeral home director and the family members during the gathering of information phase of the arrangement conference facilitates development of a rapport between the family members and the funeral home director. The use of the display screen to present the product information concerning products such as caskets and the like following the initial video and information gathering phases of the arrangement conference allows the family members to make a more simplified selection, thereby alleviating the mental distress that is otherwise caused by confronting the grieving family members with coffins in a product display room. Furthermore, the present invention includes use of a SERVICES PROVIDER to create the first and second audio-visual presentations, the LIFE STORY, and the LIFE PANEL at a location that is remote from the individual funeral homes that are part of the network. Information can be transmitted electronically from the individual funeral homes that are part of the network to the central processing center of the SERVICES PROVIDER. Because the SERVICES PROVIDER generates the audio-visual presentation 2, and also creates the audio-visual and printed matter utilized by the individual funeral homes, a level of experience and quality can be provided that go beyond the capability of a typical funeral home. The individual funeral homes in the system or network are typically well established funeral homes in a community, such that the funeral director and the funeral home maintain the trust and familiarity of the members of the community, but also have the capability of providing professionally created video works from the SERVICES PROVIDER.

In the foregoing description, it will be readily appreciated by those skilled in the art that modifications may be made to the invention without departing from the concepts disclosed herein. Such modifications are to be considered as included in the following claims, unless these claims by their language expressly state otherwise.

1. A method of providing funeral related services, comprising:
meeting with family members of the decedent during a planning session at a funeral home;
showing the family an audio-visual work, at least the first portion of which is substantially free of product information;
collecting information about the deceased from the family members;
utilizing at least some of the information to create a first video having text describing events in the life of the deceased;
utilizing at least some of the information to create a second video that is substantially shorter than the first video and includes limited text describing events in the life of the deceased.

2. The method of claim 1, wherein:
the first video has a length of about eight to twelve minutes.

3. The method of claim 2, including:
providing a video screen during visitation at a funeral home;
displaying the first video during visitation.

4. The method of claim 3, wherein:
the second video has a length of about three to four minutes and is shown during a memorial service.

5. The method of claim 1, including:
providing a funeral home website; and
placing at least some of the information about the deceased on the website.

6. The method of claim 5, wherein:
the website includes an area at which individuals can enter information concerning the deceased from a remote location by utilizing a global computer network.

7. The method of claim 6, wherein:
the website includes a plurality of memorials, each of which contains information concerning a single decedent, and also includes a security feature permitting only authorized personnel to gain access to the memorials to place at least some of the personal information and photographs of the deceased at the memorial on the website.

8. The method of claim 7, wherein:
the personal information and photographs of the deceased are collected at the funeral home and transmitted electronically to processing center where individuals who are not employees of the funeral home create the first and second videos.

9. The method of claim 1, wherein:
the audio-visual work includes information concerning the costs of packages of funeral products; and including:
providing funeral-related products to the family.

10. A method of selling funeral home products, comprising:
meeting with family members of the decedent at a funeral home for a planning conference;
showing the family members a video presentation; then:
asking the family members questions concerning the life of the decedent to gather facts concerning the life of the decedent; then:
presenting the family members with price information concerning products to be used for the funeral;
providing the family members with selected products;
create a visual work including images of the decedent;
showing the visual work on a display screen during visitation at the funeral home.

11. The method of claim 10, wherein:
the display screen is positioned in the same room as a casket during visitation.

12. The method of claim 10, including:
providing a processing facility that is remote from the funeral home;
electronically transmitting information concerning the life of the decedent from the funeral home to the processing facility; then:
creating the visual work at the processing facility in an electronic format; then:
electronically transmitting the visual work from the processing facility to the funeral home.

13. The method of claim 12, wherein:
the visual work is transferred to a mass storage device at the funeral home.

14. The method of claim 13, including:
creating an internet accessible website;
providing a screen on the website to permit remote users to post information concerning the decedent on the website.

15. The method of claim 14, including:
providing a kiosk with at least one computer connected to the internet;
positioning the kiosk in the funeral home during visitation so visitors can post information concerning the decedent on the website.

16. A method of selling funeral home products, comprising:
meeting with family members of the decedent at a funeral home for a planning conference;
showing the family members a video presentation; then:
asking the family members questions concerning the life of the decedent to gather facts concerning the life of the decedent; then:
presenting the family members with price information concerning products to be used for the funeral;
providing the family members with selected products;
create a visual work including images of the decedent;
showing the visual work on a display screen during a memorial service for the decedent.

17. The method of claim 16, wherein:
the visual work is shown on a projection screen at the memorial service.

18. The method of claim 16, including:
providing a processing facility that is remote from the funeral home;
electronically transmitting information concerning the life of the decedent from the funeral home to the processing facility; then:
creating the visual work at the processing facility in an electronic format; then:
electronically transmitting the visual work from the processing facility to the funeral home.

19. The method of claim 18, wherein:
the visual work comprises a first visual work having a length of about three to four minutes; and including:
creating a second visual work at the processing facility that is substantially longer than the first;
electronically transmitting the second visual work from the processing facility to the funeral home;
providing at least one visitation time period for visitation at the funeral home;
displaying the second visual work during the visitation time period.
